(19) United States
(12) Patent Application Publication
(10) Pub. No.: US 2010/0011051 A1
(43) Pub. Date: Jan. 14, 2010

(54) METHODS AND DEVICES FOR PROCESSING ONE OR MORE TEST REQUESTS BETWEEN A TESTING FACILITY AND ONE OR MORE CUSTOMERS

(75) Inventors: Benjamin A. Lawson, Van Alstyne, TX (US); Ron E. Heimbigner, McKinney, TX (US)

Correspondence Address: VERIZON;PATENT MANAGEMENT GROUP, 1320 North Court House Road, 9th Floor, ARLINGTON, VA, 22201-2909, US

(73) Assignee: Verizon Corporate Services Group Inc., Basking Ridge, NJ (US)

(21) Appl. No.: 12/170,044

(22) Filed: Jul. 9, 2008

(51) Int. Cl. G06F 15/16

(52) U.S. Cl. 709/203

(57) ABSTRACT

Methods, devices, and computer programs are provided for providing an information platform between a testing facility and customers of the testing facility. The information platform may be configured to allow customers to submit requests for testing and other information to the testing facility and check on the statuses of previously submitted requests to the testing facility over a network. The information platform may be configured to allow the testing facility to provide updates and other information to the customers over a network. The information platform may reduce the amount of time spent by the technicians of the testing facility answering emails or phone calls from the customers asking about the tests or attending meetings doing the same. Therefore the technicians may have more time to perform the actual test which may increase the output of the testing facility.

### BACKGROUND

Many corporations and other entities rely on a central testing facility or laboratory to test new product designs, changes to existing products, or to provide other testing support. A central testing facility may support several internal clients or external customers. For example, the testing facility may be a division within a corporation that supports other divisions of the corporation or the testing facility may be an independent external testing facility that supports several corporations.

With the exception of an independent external testing facility, a testing facility is typically not considered a profit center within a corporation. Therefore a testing facility may have limited resources including technicians to conduct the testing.

Over any period of time, a testing facility may receive numerous test requests and perform numerous tests for several customers. Although each test may be one of many tests for the testing facility, the test may be of particular concern for the requester of the test. Therefore the requester may be anxious for updates. For example, the requester may call, send emails, or request that the technician attend a meeting in order to provide updates about the test. However, such activities interfere with the technician's ability to perform that test and other tests or to keep other customers informed about their test.

### BRIEF DESCRIPTION OF THE SEVERAL VIEWS OF THE DRAWING(S)

FIG. 1 is a block diagram of a data network consistent with an exemplary embodiment;

FIG. 2 is a block diagram of a computer device consistent with an exemplary embodiment;

FIG. 3 is a block diagram of a graphical user interface consistent with an exemplary embodiment;

FIG. 4 is a flow chart illustration of a method consistent with an exemplary embodiment;

FIG. 5 is a flow chart illustration of a method consistent with another exemplary embodiment; and

FIG. 6 is a flow chart illustration of a method consistent with yet another exemplary embodiment.

### DETAILED DESCRIPTION OF PREFERRED EMBODIMENTS

Exemplary embodiments are described hereinafter with reference to the accompanying drawings, in which exemplary embodiments and examples are shown. Like numbers refer to like elements throughout.

Embodiments generally relate to methods, computer program products, devices, and systems for providing an information platform or gateway between a testing facility and customers of the testing facility. In general, the information platform may be configured to allow customers to submit requests for testing and other information to the testing facility and check on the updates or statuses of previously submitted requests to the testing facility. The information platform may be configured to allow the testing facility to provide the updates and other information to the customers. In some embodiments, the information platform may facilitate the capturing and dissemination of information or metrics regarding the operations of the testing facility that may be used for future resource allocation and other planning purposes.

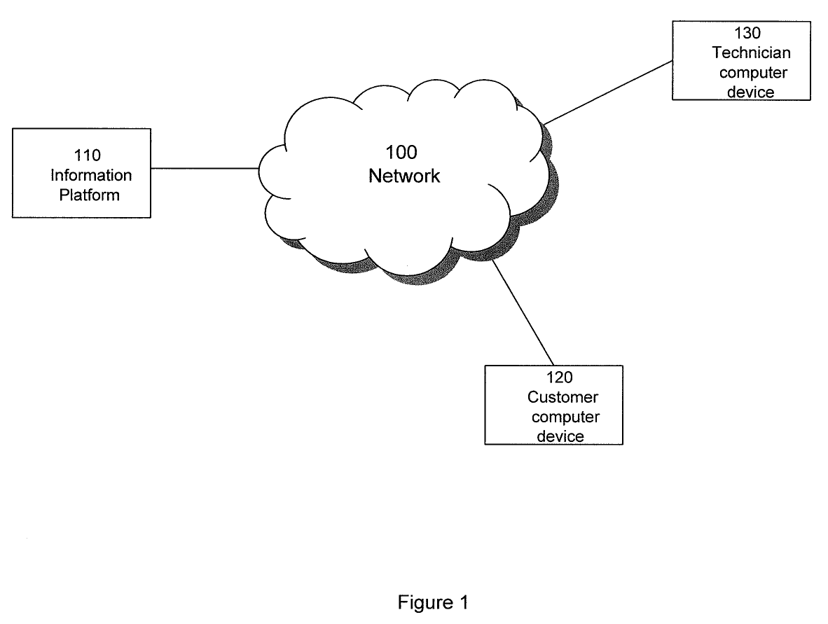

FIG. 1 illustrates a system of one or more computer devices 110, 120, 130. The computer devices 110, 120, 130 may be communicatively coupled to one another through one or more networks 100 for receiving and transmitting information to each other. A computer device may be a workstation, desktop, a laptop, a server, or other computing device having various communication programming applications such as email, Internet browser, instant or text messaging, or voice over IP (VOIP) applications. Other examples of computer devices include, but are not limited to, cellular phones, personal digital assistants (“PDA”), or any other wireless personal communication system (“PCS”) operable within a network. The network or networks may be wired or wireless (e.g., cellular, satellite) or a combination of both. A network may include or be part of a Wide Area Network (“WAN”), a Local Area Network (“LAN”), an intranet and/or the Internet.

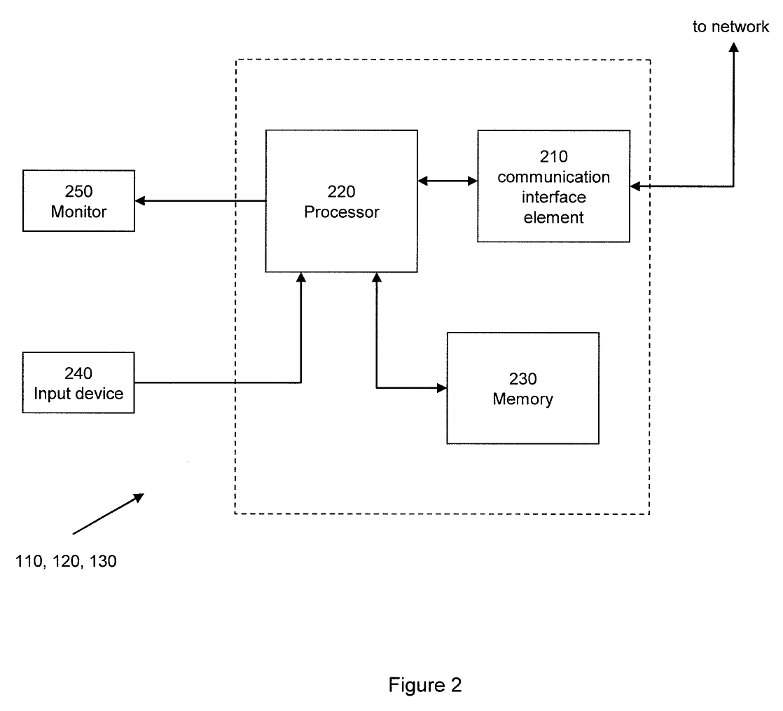

As shown in FIG. 2, a computer device 110, 120, 130 may include an interface element 210 (e.g., a receiver element and a transmitter element), a processor 220, a memory element 230, an associated user input device 240, and an associated monitor 250.

The interface element 210 (e.g., a wired or wireless network interface card (“NIC”) or a modem) is configured to send and receive data to and from the computer device to another computer device through the network or networks 100.

The processor 220 may be configured to provide processing and command functions, which may include translation or conversion of data received through the network 100 or between associated software applications of the computer device 110, 120, 130. The processor 220 may be able to send signals suitable for display on the associated monitor 250 and/or in accordance with the associated software applications of the computer device 110, 120, 130. The memory element 230 may maintain at least some of the programming instructions pertaining to the functions and operability of the computer device 110, 120, 130. The computer device 110, 120, 130 may have various software applications either stored in the memory element 230 and/or stored in another computer-readable medium (e.g., DVD, CD, disk drive, zip drive, etc).

The computer device 110, 120, 130 may have one or more associated user input devices 240. A user input device 240 may be integrated into the computer device 110, 120, 130 or be a peripheral device in communication with the computer device 110, 120, 130. In general, a user input device 240 is configured to allow an operator to enter commands or selections into the computer device 110, 120, 130. For example, the user input device 240 may be a mouse, a keyboard, a touch screen mechanism, or an audio or video sensor.

At least one of the computer devices 110 may function as an information platform. For example, the information platform 110 may receive and store information regarding test requests, updates, and statuses and other information about the operations of the testing facility. Also, the information platform 110 may send particular information about requests, updates, and statuses to other computer devices 120, 130.

For example, a customer, such as an engineer from a division of a corporation, may send a request for a particular test to be performed on a product or system. The customer may send the request from a computer device, such as his or her laptop or desktop, referred to herein as a customer computer device 120, to the testing facility or, more particularly, to the information platform 110 through the network 100.

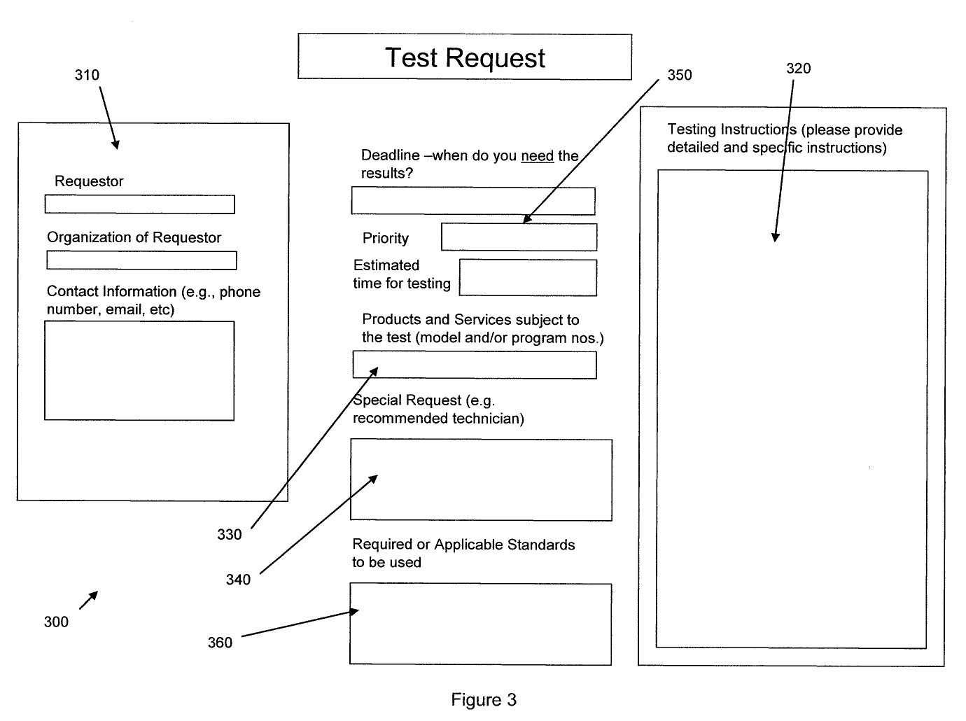

One of the software applications of the customer computer device 120 may provide the programming instructions for the processor 220 to display a graphical user interface (“GUI”) on the monitor and to receive user input via the GUI to allow the customer to provide the information for the test request. The required and optional information fields may be based on the needs or preferences of the testing facility and may vary. FIG. 3 provides an example of a GUI 300 that may be used to allow the customer to provide the necessary or preferred information. As illustrated, the information may include information about the customer or requester 310 (e.g., the division, the individual or point of contact, contact information), the test specification 320 (e.g., testing inputs and measured outputs), affected products 330, additional or special instructions 340 (e.g., preferred technician to perform testing), deadlines or other timing issues 350 (e.g., estimated number of man hours, priority level). As for test specification, the customer may be able to indicate whether a particular industry or government standard 360 should be used. In some embodiments, the customer may be able to send a copy of the standard to the information platform to be retrieved by the testing facility and/or be able to select a standard previously stored in the information platform 110.

Upon receipt of the test request, the information platform may be configured to automatically notify the testing facility. For example, the information platform may be configured to send an email or page to a particular person, such as the manager or a technician, of the testing facility or to send a message to particular device indicating the new test request without requiring an inquiry from the testing facility.

Alternatively, the information platform may be configured to send an automatic notification for only some of the test requests to the testing facility or none at all. For example, the information platform may be configured to a send a notification of the test request automatically to a particular person or device if the test request meets a predetermined criterion. The criterion may include a priority level for the request, the identity of the requester, or an expected level of resources needed for the test, etc. As specific examples, the criterion may be any request that has a deadline within a certain period of time from the date of request such as 24, 36, or 48 hours, any request in which the requester indicates a top priority level, any request that has an expected man hours of over 100, 200, or 300 hours, or related to particular products or services considered significant or a priority by the testing facility or the corporation.

Rather than or in addition to receiving a notification of a test request, the testing facility or, more specifically, a manager or technician of the testing facility may access the requests stored in the information platform 110. For example, the technician may use a computer device, referred to herein as the technician computer device 130, to view or retrieve information from the information platform 110, including a test request. Similar to the customer computer device 120, one of the software applications of the technician computer device 130 may provide the programming instructions for the processor 220 to display a graphical user interface (“GUI”) on the monitor and to receive user input via the GUI to allow the technician to request information from the information platform 110.

As an example, the technician may request to see all unassigned test requests received by the information platform 110. As used herein, an unassigned test request is a test request that has been received by the information platform but has not been assigned to a particular technician or otherwise scheduled by the testing facility. Similarly, an assigned test request is a test request that has been either assigned to a particular technician or is otherwise scheduled by the testing facility to be performed. Referring back to the example, the technician or manager may request all of the unassigned test requests so the technician or manager may either assign a technician to or schedule the unassigned test requests.

In addition to requesting the unassigned test requests, the technician or manager may be able to request and retrieve all of the assigned test requests. Allowing the manager to retrieve such information may provide the manager with a project management tool. Specifically, the manager may be able to review all of the test requests in order to be able to allocate or prioritize his or her resources appropriately. For example, in addition to the test requests, the manager may be able to retrieve information about his or her technicians from the information platform 110 including their availability or lack thereof. This may allow the manager to more efficiently schedule or reschedule the technicians to the test requests or to provide better estimates to the customers on when their individual tests will be performed.

In some instances, depending on the internal procedures of the corporation or the relationship between the testing facility and its customers, it may be required or desirable to receive authorization from or provide notification to a third party before assigning a test request or proceeding with the testing. Examples may include, but are not limited to, a finance group approving the necessary financial resources for the testing or a certification group (e.g., a group that must approve the testing protocol or procedure in order to ensure compliance to a particular standard or certification). In such instances, the information platform 110 may be configured to also send a notification of the test request to the third party. Or in other embodiments, the testing facility or, more specifically, either a technician or manager through the technician computer device 130 can send a notification of the request to the appropriate third parties. If authorization for a third party is necessary, the testing facility may wait for receipt of the authorization before assigning the test request. The receipt may be through the third party sending the authorization through the network 100 to the testing facility either directly or by way of the information platform 110.

Also, in the event that the test request is lacking information or fails to meet certain other requirements, the test request may be rejected. For example, the information platform 110 may be configured to review the test request to see whether the test request meets a predetermined criterion. The criterion may include that each required information field of the test request contains at least some information. In other words, if one of the required fields is empty, then the information platform may automatically send the test request back to the requester for the missing information. The criterion may include a timing check. Examples may be if the test request includes a deadline that has already past then the test request is rejected or if the estimated man power exceeds the number of hours before the deadline then the test request is rejected.

Rather than or addition to the information platform 110 rejecting a test request based on a predetermined criterion, the technician or manager of the testing facility may review the test request and reject the test request if it fails one of the requirements. The rejection may be sent to the customer requesting the test. For example, the rejection may be sent to the information platform 110 and then to the customer computer device 120.

Once a test request is assigned, the technician may use his or her computer device 130 to send updates to the information platform 110. For example, the technician may send information to the information platform 110 regarding the progress or status of the test, referred to herein as an update. The progress or status may be a completion or partial completion of a testing step or milestone, results and observations to date, and/or estimated time to completion.

The information platform 110 may be configured to send none, some, or all of the updates to the customer associated with the test request, e.g., the requester. More specifically, the information platform 110 may be configured send an email or page to a particular person, such as the requester, or to send a message to particular computer device. Whether or not the information platform 110 sends the update to the requester may be dependent on a predetermined criterion. If the update meets the criterion, the information platform 110 may be configured to send the update. Otherwise, the information platform 110 may not send the update automatically to the requester in response to receiving the updates.

The criterion on whether or not the update is sent to the customer may vary. For example, the customer may establish the criterion when he or she makes the test request, which may include providing milestones. If the update is the completion of the milestone then the information platform may send the update to the customer. As another example, the criterion may be based on a timing issue such as a change in the estimated time of complete.

The customer may be able to access the information platform 110 to review any information about his or her test including any updates. For example, the customer may send an inquiry about his or her test request to the information platform 110 from his or her computer device 120 through the network 100. Such a system allows the customers to check the statuses of their test at anytime. Also, the system may reduce the amount of time spent by the technicians answering emails or phone calls from the customers asking about the tests or attending meetings doing the same. Therefore the technicians may have more time to perform actual tests which may increase the output of the testing facility.

To help track a particular test request, each test request may be assigned a unique identifier such as a contract number or job number. The unique identifier may be assigned by the information platform 110 based on when the test request was received and/or based on the requester.

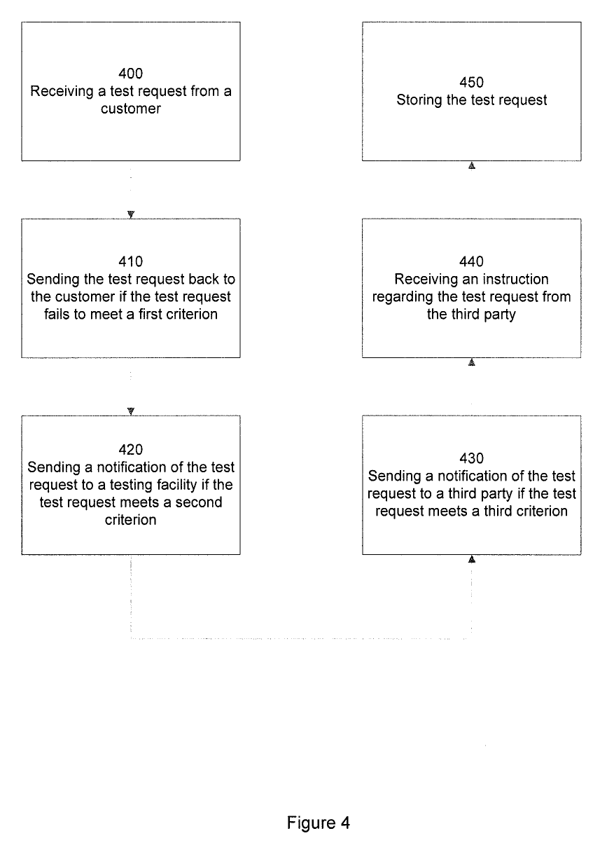

FIG. 4 illustrates an example of a method for processing test requests between a testing facility and its customers. The method may include receiving a test request from a customer 400. For example, the test request may be sent from a customer computer device to the information platform. The test request may be compared against a first criterion. If the test request fails to meet the first criterion, the test request may be rejected and sent back to the customer 410. The test request may also be compared against a second criterion. If the test request meets the second criterion, a notification of the test request may be sent to the testing facility 420. The test request may also be compared against a third criterion to determine whether a third party should be notified of the test request. If the test request meets the third criterion, a notification of the test request may be sent to the third party 430. The method may further include receiving an instruction from the third party regarding the test request 440. For example, the instruction may be the authorization or disapproval of the test request. The method may further include storing the test request 430.

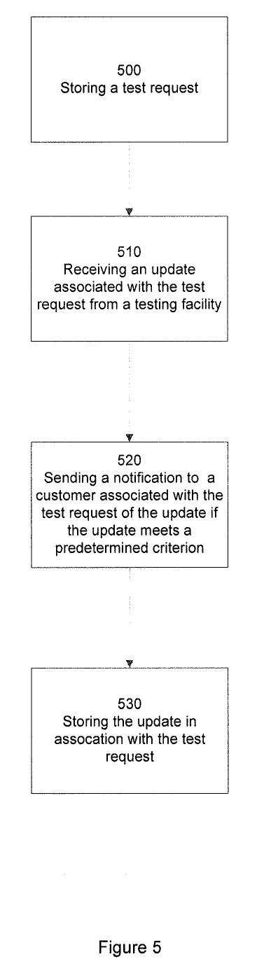

FIG. 5 illustrates an example of a method of processing test requests and updates for the test requests. The method may include storing a test request 500 and receiving an update about the test request from a testing facility 510. The update may be compared to a predetermined criterion. If the update meets the predetermined criterion then a notification of the update may be sent to the customer associated with the test request 520. The method may further include storing the update in association with the test request 530. For example, an update and a test request may be stored as two separate data objects that are linked together. Or as another example, an update may append, modify, or write to an existing data object already linked to or part of a test request.

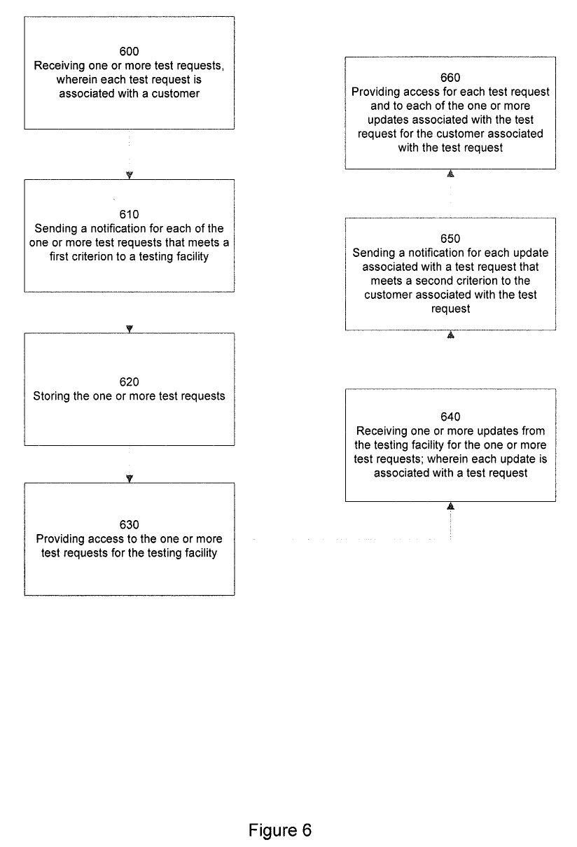

Although most of the discussion has been directed to a test request and an update regarding that test request, it is understood that the teachings herein apply equally in the context of multiple test requests, updates, and customers. For example, FIG. 6 illustrates a method of processing a plurality of test requests and updates. The method may include receiving and storing one or more test requests 600, 620, sending a notification to a testing facility for each test request that meets a first criterion 610, and providing access to the one or more test requests for the testing facility 630. The method may further include receiving one or more updates from the testing facility for one or more of the test requests, wherein each update is associated with a test request 630, sending a notification for each update associated with a test request that meets a second criterion to the customer associated with the test request 650, and providing access for each test request and to each of the one or more updates associated with the test request for the customer associated with the test request 660.

The access to the test requests and the updates may be provided to the interested parties, e.g., the testing facility and the customers, which allows each party to obtain current information regarding their test requests or other information related to the operations of the testing facility.

The operations described above and illustrated in FIGS. 4 through 6 may be performed by the information platform or other computer device. As explained above, the information platform may include a processor to perform the operations and at least one memory element for storing the test requests, updates, and other information including software instructions for performing the operations.

The processor of the information platform may be embodied various ways. For example, the processor may be embodied as a coprocessor, a controller or various other processing means or devices including integrated circuits such as, for example, an application specific integrated circuit (“ASIC”).

The memory elements described herein may be various memory structures including volatile and non-volatile memory structures. Any of the memory elements may be configured to store information, data, applications, instructions or the like for enabling the devices disclosed herein to carry out various functions in accordance with exemplary embodiments, such as by storing software that is executable by the processor to cause the various functions of the processor that are described herein to be performed. For example, a memory element could be configured to buffer input data for processing by a respective processor.

Although the operations or functions described above have been attributed to mostly hardware components, such as a server or other computer device, one or more of the operations or functions may be combined and performed through software or a combination of software or hardware. As an example, in some embodiments a computer program product stored on a computer-readable storage medium (e.g., software) comprising of one or more executable portions may perform the operations or functions described above.

The information platform 110 and the technician computer device 130 are illustrated and generally described as two separate devices 110, 130 separated by the network 100. However, the two devices may be combined into one. More specifically, a technician computer device 130 may be configured to perform the operations described above as being performed by the information platform 110.

Above embodiments disclose capturing a test request through a customer submitting a test request from his or her computer device to the information platform which makes the test request accessible to the testing facility. However, the manner in which the test request is captured may vary. For example, in other embodiments, a customer may deliver a test request directly to the testing facility including by submitting only a paper copy of the test request. In such instances, the testing facility may send the test request to the information platform.

In the preceding specification, various embodiments of the claimed invention have been described. It will, however, be evident that various modifications and changes may be made thereunto without departing from the broader spirit and scope of the invention as set forth in the claims that follow. The specification and drawings are accordingly to be regarded in an illustrative rather than restrictive sense.

That which is claimed:

1. A method comprising:
receiving one or more test requests, wherein each test request is associated with a customer;
storing the one or more test requests;
providing access for a testing facility to the one or more test requests;
receiving one or more updates, wherein each update is associated with a test request;
sending a notification over a network for each update associated with a test request that meets a first criterion to the customer associated with the test request; and
providing access to each test request and to each of the one or more updates associated with the test request for the customer associated with the test request.

2. The method of claim 1 further comprising sending a notification for each of the one or more test requests that meets a second criterion to the testing facility.

3. The method of claim 2 further comprising rejecting a test request that fails to meet a third criterion.

4. The method of claim 3 further comprising sending a notification to a third party over a network of each of the one or more test requests that meets a fourth criterion.

5. The method of claim 4 further comprising receiving an instruction from the third party over the network regarding the test request.

6. A computer program product comprising a computer-readable storage medium having computer-readable program code portions stored therein, the computer-readable program code portions comprising:
a first executable portion for receiving one or more test requests, wherein each test request is associated with a customer;
a second executable portion for storing the one or more test requests;
a third executable portion for providing access for a testing facility to the one or more test requests;
a fourth executable portion for receiving one or more updates for the one or more test requests, wherein each update is associated with a test request; and
a fifth executable portion for providing access to each test request and to each of the one or more updates associated with the test request for the customer associated with the test request.

7. The computer program product according to claim 6 further comprising a sixth executable portion for sending a notification for each update associated with a test request that meets a predetermined criterion to the customer associated with the test request.

8. The computer program product according to claim 6 further comprising a sixth executable portion for sending a notification for each of the one or more test requests that meets a predetermined criterion to the testing facility.

9. The computer program product according to claim 6 further comprising a sixth executable portion for rejecting a test request that fails to meets a predetermined criterion.

10. The computer program product according to claim 6 further comprising a sixth executable portion for sending a notification to a third party of each of the one or more test requests that meets a predetermined criterion.

11. The computer program product according to claim 10 further comprising a seventh executable portion for receiving an instruction from the third party regarding the test request.

12. A device comprising a processor configured to receive one or more test requests, wherein each test request is associated with a customer; to provide access for a testing facility to the one or more test requests; to receive one or more updates for the one or more test requests, wherein each update is associated with a test request; and to provide access for each test request and to each of the one or more updates associated with the test request from the customer associated with the test request.

13. The device according to claim 12, wherein the processor is further configured to send a notification for each update associated with a test request that meets a predetermined criterion to the customer associated with the test request.

14. The device according to claim 12, wherein the processor is further configured to send a notification to the testing facility for each of the one or more test requests that meets a predetermined criterion.

15. The device according to claim 12, wherein the processor is further configured to reject a test request that fails to meets a predetermined criterion.

16. The device according to claim 12, wherein the processor is further configured to send a notification of each of the one or more test requests to a third party that meets a predetermined criterion.

17. The device according to claim 16, wherein the processor is further configured to receive an instruction from the third party regarding the test request.

18. A method comprising:
storing a plurality of test requests, wherein each test request is associated with a customer;
receiving one or more updates, wherein each update is associated with a test request of the plurality of test requests;
storing the one or more updates;
receiving an inquiry over a network regarding a status of a first test request of the plurality of test requests; and
providing access over a network to the first test request and each of the one or more updates associated with the first test request.

19. The method according to claim 18 further comprising receiving a test request over a network and sending notification of the test request to a testing facility.

20. The method according to claim 18 further comprising sending a notification over a network for each of the one or more updates associated with a test request that meets a first criterion to the customer associated with the test request.
